(19) United States
(12) Patent Application Publication
(10) Pub. No.: US 2025/0302005 A1
(43) Pub. Date: Oct. 2, 2025

(54) Pet Paw Boots with Movement Activated Lighting Device

(71) Applicant: Ivy Angel, Waldorf, MD (US)

(72) Inventor: Ivy Angel, Waldorf, MD (US)

(21) Appl. No.: 18/760,303

(22) Filed: Jul. 1, 2024

Related U.S. Application Data
(60) Provisional application No. 63/571,014, filed on Mar. 28, 2024.

(51) Int. Cl. A01K 13/00; A01K 29/00; F21L 4/08; F21V 23/04; F21V 33/00; F21Y 107/30; F21Y 113/00; F21Y 115/10

(52) U.S. Cl. CPC A01K 13/007; A01K 29/005; F21L 4/08; F21V 23/0492; F21V 33/0008; F21Y 2107/30; F21Y 2113/00; F21Y 2115/10

(57) ABSTRACT

Pet paw boots with movement activated lighting device is disclosed that helps pet owners maintain visibility of their pet in dimly lit or inclement weather conditions are disclosed. The dog paw boots with movement activated lighting devices comprise a base component or portion with an illumination component or portion. Further, a body component or portion is comprised of an adjustable strap to secure the device to the canine. The device can illuminate when motion is detected, or pressure is placed down on the device. Additionally, canines become visible to other pedestrians and drivers, preventing accidents in poor conditions. Further, tracking technology can be added to the device to ensure the location of the canine. The device also includes a battery pack to power the illumination components.

### CROSS-REFERENCE TO RELATED APPLICATION

The present application claims priority to, and the benefit of, U.S. Provisional Application No. 63/571,014, which was filed on Mar. 28, 2024, and is incorporated herein by reference in its entirety.

### FIELD OF THE INVENTION

The present invention relates generally to the field of canine footwear devices. More specifically, the present invention relates to improved canine footwear with illuminating component or portions to ensure visibility of the canine in various conditions to enable owners to easily locate their pet. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in canine footwear devices. Generally, when walking at night or in dimly lit areas, it can be difficult to see a canine. A canine can be placed in a significant amount of danger if the animal runs off from its owner, due to poor visibility. Further, high traffic areas put the animals at high risk for an accident without a way to alert drivers of their presence. Moreover, canines can be difficult to find in the scenario due to dim lighting or poor weather conditions.

Additionally, there are times when canine paws need protection from inclement conditions such as rain or snow. At such times, if dog paw boots with movement activated lighting device are available, this enables users to protect canine paws from inclement conditions. Further, they can prevent damage to the canine's paws and provide the canine with stability in these conditions.

Accordingly, there is a demand for an improved canine footwear device with illuminating component or portions to ensure visibility of the canine in various conditions to enable owners to easily locate their pet. More particularly, there is a demand for dog paw boots with movement activated lighting device that enables the canine to be visible from a distance to pedestrians and drivers in high traffic areas, preventing accidents with canines.

Therefore, there exists a long-felt need in the art for dog paw boots with movement activated lighting device to ensure visibility of the canine in various conditions to enable owners to easily locate their pet. There is also a long-felt need in the art for dog paw boots with movement activated lighting device that enables other drivers and pedestrians to easily see the canine from a distance, reducing the risk of a potential traffic accident. Further, there is a long-felt need in the art for dog paw boots with movement activated lighting device that enables pet owners to maintain visibility in the event their canine runs off at night. Moreover, there is a long-felt need in the art for an improved canine footwear device that provides protection and support in inclement conditions such as rain and snow while providing visibility to pet owners, drivers, and pedestrians. Finally, there is a long-felt need in the art for dog paw boots with movement activated lighting device that provides users with small, medium, and large size options to ensure the safety of all pets.

The subject matter disclosed and claimed herein, in one embodiment thereof, comprises dog paw boots with movement activated lighting device. The device is a set of dog paw boots with movement activated lights that provide illumination to maintain pet visibility in all conditions. The dog paw boots with movement activated lighting device comprises a base component or portion. Further, an illumination component or portion is embedded within the base component or portion. The device can illuminate when the device is put into motion by the dog's paws. The device also includes a battery switch pack, which can be used to power the device. The battery switch pack may also control the colors and patterns of the lights. Additionally, the device comprises a body with an adjustable strap component or portion to secure the boot to the paw. Further, the adjustable strap prevents the boot from being removed from the paw. The device also accounts for protection of the paws during inclement weather and stability of the paw during the movements from the canine.

In this manner, the dog paw boots with movement activated lighting device of the present invention accomplishes all of the foregoing objectives and provides users canine footwear featuring integrated lights to provide visibility of their pet. The device is canine footwear that illuminates in various weather conditions. The device provides drivers and pedestrians visibility of pets in dimly lit areas preventing motor vehicle accidents.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises dog paw boots with movement activated lighting device. The device is illuminated canine footwear to ensure visibility of the pet in various conditions. Additionally, the canine footwear protects the canine's paws from abrasion and extreme temperatures (i.e., heat and cold) when walking on various terrains and during various weather conditions. The dog paw boots with movement activated lighting device comprises a base component or portion that illuminates when in motion. Additionally, the movement activated light component or portion enables pet owners to find their pet if they were to become detached from a leash in dimly lit conditions. Further, the movement activated light component or portion notifies other pedestrians and drivers of the pets' presence and/or whereabouts, preventing an accident.

In one embodiment, the dog paw boots with movement activated lighting device comprises the following component or portions: a base component or portion, an illumination component or portion, which is motion activated when powered on, and a body component or portion. Other items may be added to create additional functionality or increase safety, as needed.

In one embodiment, the base component or portion is preferably made from a slip-resistant material, such as rubber, to provide additional support for the canine and to provide a water-resistant seal while in use. Additionally, the base component or portion is comprised of a movement activated illumination component or portion that enables the canine to be easily located in dimly lit conditions.

In one embodiment, the body component or portion is preferably made from a weather resistant material such as plastic or nylon to withstand outdoor weather conditions. Additionally, the body component or portion is comprised of an adjustable strap that secures the device to the canine's paws. This ensures the device is not removed from the canine's paws while in motion. Further, the adjustable strap enables the device to be attached to paws of various widths.

In another embodiment, the dog paw boots with movement activated lighting device comprises a plurality of indicia.

In another embodiment, a method of securing and illuminating the device is disclosed. The method includes the steps of providing dog paw boots with movement activated lighting device comprising a base component or portion, illumination component or portion, and body component or portion. The method also comprises placing the device on at least one paw of the canine. Further, the method comprises securing each boot to at least one canine paw using the adjustable strap. The method also comprises switching the illumination component or portion to the on position. Finally, the method comprises activating the illumination component or portion through the canine becoming active.

Accordingly, the dog paw boots with movement activated lighting device of the present invention is particularly advantageous as it provides a device that illuminates while in motion. More specifically, the dog paw boots with movement or motion activated device can be used in a plurality of weather conditions to provide illumination to pet owners, pedestrians, and drivers. Furthermore, the device can be universally applied to a plurality of animals.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the dog paw boots with movement activated lighting device of the present invention in accordance with the disclosed architecture;

FIG. 2 illustrates a perspective view of one embodiment of the dog paw boots with movement activated lighting device of the present invention showing the lights embedded into the base component or portion of the device in accordance with the disclosed architecture;

FIG. 3 illustrates a perspective view of one embodiment of the dog paw boots with movement activated lighting device of the present invention showing how the lights are motion activated in accordance with the disclosed architecture;

FIG. 4 illustrates a perspective view of one embodiment of the dog paw boots with movement activated lighting device of the present invention showing the product in use in a dimly lit area in accordance with the disclosed architecture;

FIG. 5 illustrates a perspective view of one embodiment of the dog paw boots with movement activated lighting device of the present invention showing how the lights are activated with each step in accordance with the disclosed architecture; and

FIG. 6 illustrates a flowchart showing the method of securing and powering the dog paw boots in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for dog paw boots with movement activated lighting device with illuminating component or portions to ensure visibility of the canine in various conditions to enable owners to easily locate and detect their pet. There is also a long-felt need in the art for dog paw boots with movement activated lighting device that enables other drivers and pedestrians to easily see the canine from a distance, reducing the risk of a potential traffic accident. Further, there is a long-felt need in the art for dog paw boots with movement activated lighting device that enables pet owners to maintain visibility of their pet in the event their canine runs off at night. Moreover, there is a long-felt need in the art for an improved canine footwear device that provides protection and support in inclement conditions such as rain and snow while providing visibility to pet owners, drivers, and pedestrians. Finally, there is a long-felt need in the art for dog paw boots with movement activated lighting device that provides users with small, medium, and large size options to ensure the safety of all pets.

The present invention, in one exemplary embodiment, is dog paw boots with movement or pressure activated lighting device. The device can illuminate when it is in motion to help canine owners, pedestrians, and motor vehicle operators to be alerted to a canine's location. The dog paw boots with movement or motion activated device comprises a base component or portion with at least one embedded illumination component or portion and a body component or portion. Further, the body component or portion comprises at least one adjustable strap to secure the device to the paw of the canine. The method includes the steps of providing dog paw boots with movement activated lighting device comprising a base component or portion, an illumination component or portion, and a body component or portion. The method also comprises placing the device on at least one paw of the canine. Further, the method comprises securing each boot to at least one canine paw using the adjustable strap. The method also comprises switching the illumination component or portion to the on position. Finally, the method comprises activating the illumination component or portion through the canine becoming active (i.e., motion).

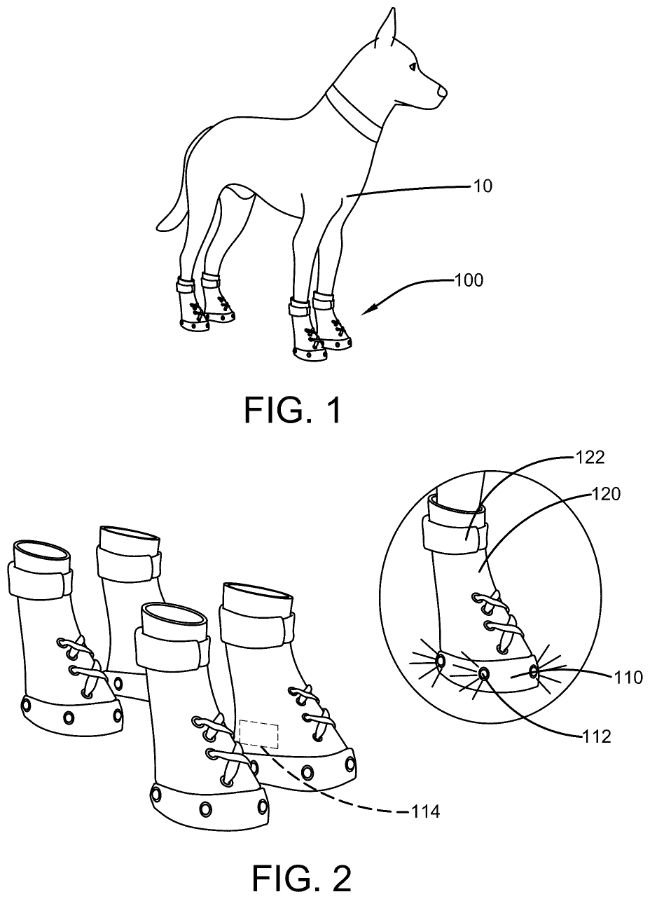

Referring initially to the drawings, FIG. 1 illustrates a perspective view of one embodiment of the dog paw boots with movement activated lighting device 100 of the present invention. In the present embodiment, the dog paw boots with movement activated lighting device 100 is an improved canine footwear device 100 with a means for illumination to identify the canine's 10 location. Specifically, the dog paw boots with movement activated lighting device 100 makes identification of the canine 10 more apparent to a pedestrian, driver 30, and user 20 in dimly lit areas or inclement weather conditions.

Generally, the dog paw boots device with movement activated lighting device 100 is made up, at a minimum, of the following component or portions: a base component or portion 110, a battery pack 114, an illumination component or portion (i.e., illuminator) 112, which is motion activated when powered on, and a body component or portion 120. Additional items may be added to create additional functionality or increase safety, as needed.

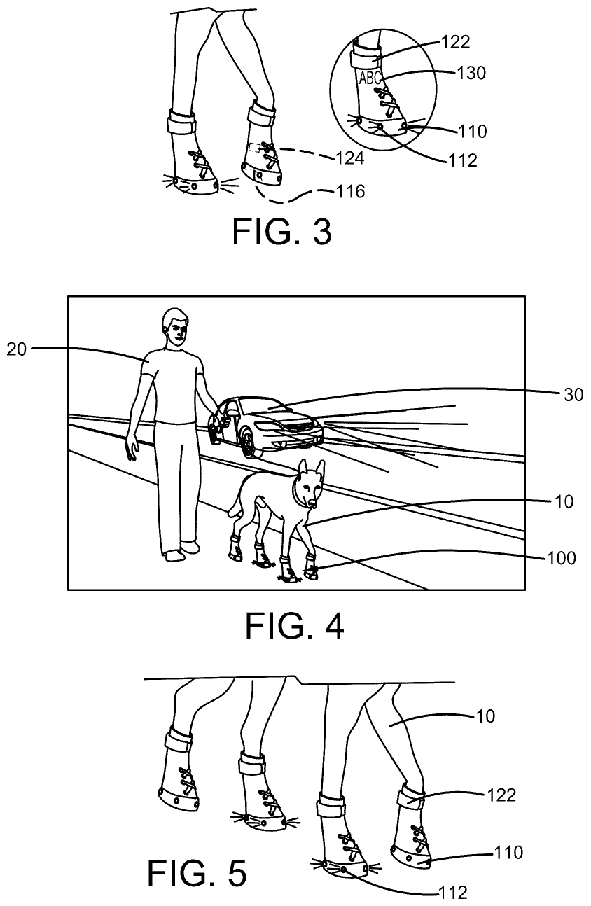

As shown in FIGS. 2-3, the base component or portion 110 can be formed using a rubber material in a circular shape, enabling for all portions of the base component or portion 110 to cover the canine's 10 paw. Additionally, the base component or portion 110 formed using a rubber material enables the illumination component or portion (i.e., illuminator) 112 to be embedded into the device 100. In some instances, the base component or portion 110 can be made of different materials such as another synthetic compound that will offer traction and durability. The material used to form the base component or portion 110 has at least one bottom recessed area 116 to prevent the canine 10 paw from slipping and to maintain traction while the device 100 is in use.

Furthermore, the base component or portion 110 comprises an illumination component or portion (i.e., illuminator) 112 that becomes activated when in motion. Typically, the illumination component or portion (i.e., illuminator) 112 is embedded around the base component or portion 110. The illumination component or portion (i.e., illuminator) 112 is often formed using LED lights embedded around the base component or portion 110. The type of illumination component or portion (i.e., illuminator) 112 can vary and is not limited to LED lights. The illumination component or portion (i.e., illuminator) 112 can selectively be powered or actuated using the battery/switch pack component or portion 114. The type of battery used to power the battery/switch pack 114 can vary, such as rechargeable battery or replaceable battery. In one embodiment, the battery/switch pack 114 when actuated enables the user 20 to turn ON the illuminator 112 and/or change the color and pattern of the illuminator 112.

Additionally, the base component, or portion 110 is secured to the body component or portion 120. The body component or portion 120 is preferably made from a weather resistant material such as plastic, nylon, or water-resistant canvas to withstand outdoor weather conditions. The body component or portion 120 provides protection to the canine's 10 paws in inclement weather conditions such as, but not limited to, rain, snow, and ice.

In a further embodiment, the body component or portion 120 material can be interwoven with tracking technology 124. Further, the body component or portion 120 can be interwoven with RFID, radio frequency identification device, or NFC, near field communication technology, to track the location of the device 100 and the canine 10.

Further, the body component or portion 120 is comprised of at least one adjustable strap 122 that secures the device 100 to the canine's 10 paws. Typically, the adjustable strap component or portion 122 is made from hook and loop fasteners. This enables the adjustable strap component or portion 122 to be secured to various leg widths. Furthermore, this ensures the device 100 is not removed from the canine's 10 paw while in motion.

In yet another embodiment, the dog paw boots with movement activated lighting device 100 comprises a plurality of indicia 130. The body component or portion 120 of the device 100 may include advertising, a trademark, or other letters, designs, or characters, printed, painted, stamped, or integrated in the body component or portion 120, or any other indicia 130 as is known in the art. Specifically, any suitable indicia 130 as is known in the art can be included, such as, but not limited to, patterns, logos, emblems, images, symbols, designs, letters, words, characters, animals, advertisements, brands, etc., that may or may not be dog paw boots or brand related. Further, the dog paw boots with movement or motion activated device 100 can be a plurality of sizes to fit various canines 10.

As shown in FIGS. 4-5, in one embodiment, the device 100 is operated in dimly lit conditions. The user 20 is walking the canine 10 with the dog paw boots with movement or motion activated lights 100. Additionally, the driver 30, can identify and detect the canine 10 by the illuminated dog paw boots with movement or motion activated device 100.

Generally, the use of the present invention is straightforward. The user 20 secures the device 100 to at least one paw of the canine 10. The user 20 initiates the movement of the canine 10. Once the canine 10 is in motion, the illumination component or portion (i.e., illuminator) 112 is activated with each step of the canine 10. This technology enables the user 20 and driver 30 to maintain visibility of the canine 10 even if the canine 10 escaped from the leash.

The device 100 is intended for the use by canines 10, but it is not limited to, the use of canines 10. Further, the device 100 can be used on a plurality of animals to maintain visibility and location via tracking technology 124.

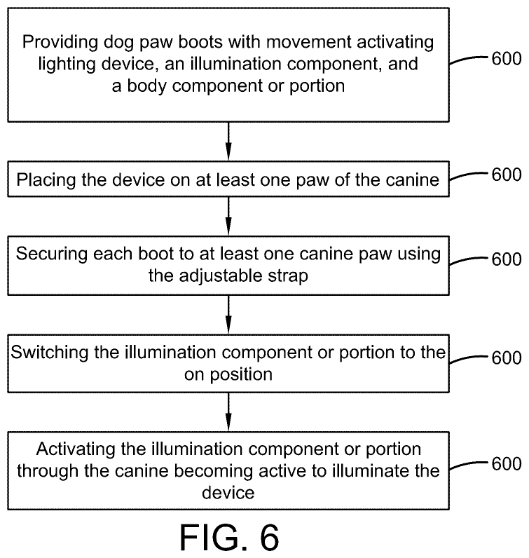

FIG. 6 illustrates a flowchart of the method of securing and illuminating the device 100 is disclosed. The method includes the steps of at 600, providing dog paw boots with movement activated lighting device comprising a base component or portion, illumination component or portion, and body component or portion. The method also comprises at 602, placing the device on at least one paw of the canine. Further, the method comprises at 604, securing each boot to at least one canine paw using the adjustable strap. The method also comprises at 606, switching the illumination component or portion to the on position. Finally, the method comprises at 608, activating the illumination component or portion through the canine becoming active to illuminate the device.

Certain terms are used throughout the following description and claims to refer to particular features or component or portions. As one skilled in the art will appreciate, different users may refer to the same feature or component or portion by different names. This document does not intend to distinguish between component or portions or features that differ in name but not structure or function. As used herein “dog paw boot”, “canine footwear device”, “movement activated lighting device”, and “lighting device” are interchangeable and refer to the pet paw boots with movement activated lighting device 100 of the present invention.

Notwithstanding the foregoing, the pet paw boots with movement activated lighting device 100 of the present invention can be of any suitable size and configuration as is known in the art without affecting the overall concept of the invention, provided that it accomplishes the above-stated objectives. One of ordinary skill in the art will appreciate that the pet paw boots with movement activated lighting device 100 as shown in FIGS. 1-6 is for illustrative purposes only, and that many other sizes and shapes of the pet paw boots with movement activated lighting device 100 are well within the scope of the present disclosure. Although the dimensions of the pet paw boots with movement activated lighting device 100 are important design parameters for user convenience, the pet paw boots with movement activated lighting device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of component or portions or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dog paw boot with movement activated lighting device comprising:
a base portion;
a body portion;
a battery pack; and
an illuminator;
wherein said base portion housing said illuminator and said battery pack;
wherein said body portion surrounding a dog paw;
wherein switching said battery pack to an ON position; and
further wherein motion actuating said illuminator.

2. The dog paw boot with movement activated lighting device of claim 1 further comprising an adjustable strap positioned at a top end of said body portion for securing said paw boot to the dog paw.

3. The dog paw boot with movement activated lighting device of claim 2, wherein said base portion and said body portion having a material of rubber.

4. The dog paw boot with movement activated lighting device of claim 3, wherein said illuminator embedded in said base portion.

5. The dog paw boot with movement activated lighting device of claim 4, wherein said base portion having a circular shape.

6. The dog paw boot with movement activated lighting device of claim 5, wherein said base portion having at least one bottom recessed area for maintaining traction of said paw boot.

7. The dog paw boot with movement activated lighting device of claim 6, wherein said illuminator are LED lights.

8. The dog paw boot with movement activated lighting device of claim 7, wherein said battery pack is rechargeable.

9. The dog paw boot with movement activated lighting device of claim 7, wherein said battery pack is replaceable.

10. A dog paw boot with movement activated lighting device comprising:
a base portion;
a body portion;
a battery pack;
an illuminator; and
an adjustable strap;
wherein said base portion housing said illuminator and said battery pack;
wherein said body portion surrounding a dog paw;
wherein switching said battery pack to an ON position;
wherein motion actuating said illuminator;
wherein said illuminator are LED lights; and
further wherein said adjustable strap having a hook and loop fastener positioned at a top end of said body portion for securing said dog paw boot to the dog paw.

11. The dog paw boot with movement activated lighting device of claim 10, wherein said base portion and said body portion having a material of rubber.

12. The dog paw boot with movement activated lighting device of claim 11, wherein said illuminator embedded in said base portion.

13. The dog paw boot with movement activated lighting device of claim 12, wherein said base portion having a circular shape.

14. The dog paw boot with movement activated lighting device of claim 13, wherein said base portion having at least one bottom recessed area for maintaining traction of said dog paw boot.

15. The dog paw boot with movement activated lighting device of claim 14, wherein said battery pack is rechargeable.

16. The dog paw boot with movement activated lighting device of claim 14, wherein said battery pack is replaceable.

17. A pet paw boot with movement activated lighting device comprising:
a base portion;
a body portion;
a battery pack;
an illuminator; and
an adjustable strap;
wherein said base portion housing said illuminator and said battery pack;
wherein said body portion surrounding a pet paw;
wherein switching said battery pack to an ON position;
wherein motion actuating said illuminator;
wherein said illuminator are LED lights;
wherein said adjustable strap having a hook and loop fastener positioned at a top end of said body portion for securing said pet paw boot to the pet paw; and
further wherein said base portion having at least one bottom recessed area for maintaining traction of said pet paw boot.

18. The pet paw boot with movement activated lighting device of claim 17, wherein said base portion and said body portion having a material selected from the group consisting of a plastic, a nylon, a canvas, and a rubber.

19. The pet paw boot with movement activated lighting device of claim 18, wherein said illuminator embedded in said base portion.

20. The pet paw boot with movement activated lighting device of claim 19 further comprising a radio frequency identification device embedded to one of said base portion and said body portion to track a location of said pet paw boot.
